(19) United States
(12) Patent Application Publication
(10) Pub. No.: US 2016/0100164 A1
(43) Pub. Date: Apr. 7, 2016

(54) VIDEO ENCODING AND DECODING METHODS FOR A VIDEO COMPRISING BASE LAYER IMAGES AND ENHANCEMENT LAYER IMAGES, CORRESPONDING COMPUTER PROGRAMS AND VIDEO ENCODER AND DECODER

(71) Applicant: THOMSON LICENSING, Issy de Moulineaux (FR)

(72) Inventors: Philippe BORDES, Laille (FR); Pierre Andrivon, Liffre (FR); Franck Hiron, Chateaubourg (FR)

(21) Appl. No.: 14/873,604

(22) Filed: Oct. 2, 2015

(30) Foreign Application Priority Data
Oct. 3, 2014 (EP) 14306559.7

(51) Int. Cl. H04N 19/117; H04N 19/17; H04N 19/513; H04N 19/187

(52) U.S. Cl. CPC H04N 19/117; H04N 19/187; H04N 19/17; H04N 19/513

(57) ABSTRACT

A Video encoding method is disclosed that comprises: —receiving a video comprising a sequence of images comprising base layer images and enhancement layer images; —temporally filtering each base layer image into a temporally filtered image; —encoding the base layer images in order to produce base layer encoded video data and reconstructed base layer image; —encoding the enhancement layer images in order to produce enhancement layer encoded video data; —determining at least one parameter of a parametric filter for each reconstructed base layer image, such that applying the parametric filter with the parameter(s) to a version of the reconstructed base layer image produces a corrected base layer image which is closer to the temporally filtered image than the version of the reconstructed base layer image; —providing the base layer encoded video, the enhancement layer encoded video and the parameters.

### FIELD

The invention relates to temporal scalable video coding.

### BACKGROUND

In case of temporal scalability, it is known to produce a video comprising a sequence of images comprising base layer images and enhancement layer images, alternating with each other.

The type of each image (base layer or enhancement layer) is indicated in the video. In this manner, a video decoder operating at high frame rate (e.g. 100 Hz) will receive and decode both base and enhancement layer images. High frame rate is desirable for example for sport video. On the contrary, a video decoder operating at low frame rate (e.g. 50 Hz) will receive both layers, but will discard the enhancement layer images and will decode only the base layer images, that is to say one image out of two.

One way to produce the previously described video is to shoot the video at the higher rate (e.g. 100 Hz) and to define one image out of two as base layer images, the remaining images being defined as enhancement layer images. Doing so, an issue is to be considered: the choice of the shutter opening time of the camera.

For a given frame rate (T_{frame}) and a shutter time ratio value (Aₛₕᵤₜₜₑᵣ), motion blur due to the captor integration time occurs for displacement speed superior or equal to Vₗᵢₘᵢₜ defined by:

$${V}_{limit} = \frac{2 \times width}{{N}_{pixel} \times {T}_{frame} \times {A}_{shutter}}$$

where:

T_{frame}=frame rate,

Nₚᵢₓₑₗ=number of pixels (width)

Width=screen panel width

(T_{frame}×Aₛₕᵤₜₜₑᵣ) is the aperture time duration

For a given screen size, if Aₛₕᵤₜₜₑᵣ is chosen to avoid blur in the full rate video (comprising both the base layer images and the enhancement layer images) (T_{frame}=100 fps), the shutter time ratio value will be too short for the low rate video (comprising only the base layer images) (T_{frame}=50 fps) and there will be a stroboscopic effect.

To overcome this problem, it is possible to temporally filter (“motion blur”) the base layer images. However, this temporal filtering will also appear in the full rate video (in the base layer images) which will decrease video quality of the full rate video.

There is therefore a need for a video encoding method which is scalable and which insures good image quality when only the base layer images are decoded and also when both the base and enhancement layer images are decoded.

### SUMMARY OF THE INVENTION

It is proposed a video encoding method according to claim 1.

Thanks to the invention, a temporal filtering can be applied only when the base layer images are decoded, and not when both the base and enhancement layer images are decoded.

Other features of the method are set forth in claims 2 to 12.

It is also proposed a computer program according to claim 13.

It is also proposed a video encoder according to claim 14.

It is also proposed a video decoding method according to claim 15.

It is also proposed a computer program according to claim 16.

It is also proposed a video decoder according to claim 17.

### BRIEF DESCRIPTION OF THE DRAWING

An embodiment of the invention will now be described by way of example only and with reference to the appended figures.

FIG. 1 illustrates a video encoder according to the invention.

FIG. 2 illustrates a video encoding method according to the invention.

FIG. 3 illustrates a first video decoder according to the invention.

FIG. 4 illustrates a first video decoding method according to the invention.

FIG. 5 illustrates a second video decoder according to the invention.

FIG. 6 illustrates a second video decoding method according to the invention.

### DETAILED DESCRIPTION OF THE DRAWING

In the following description, the term “filter” encompasses any image transformation.

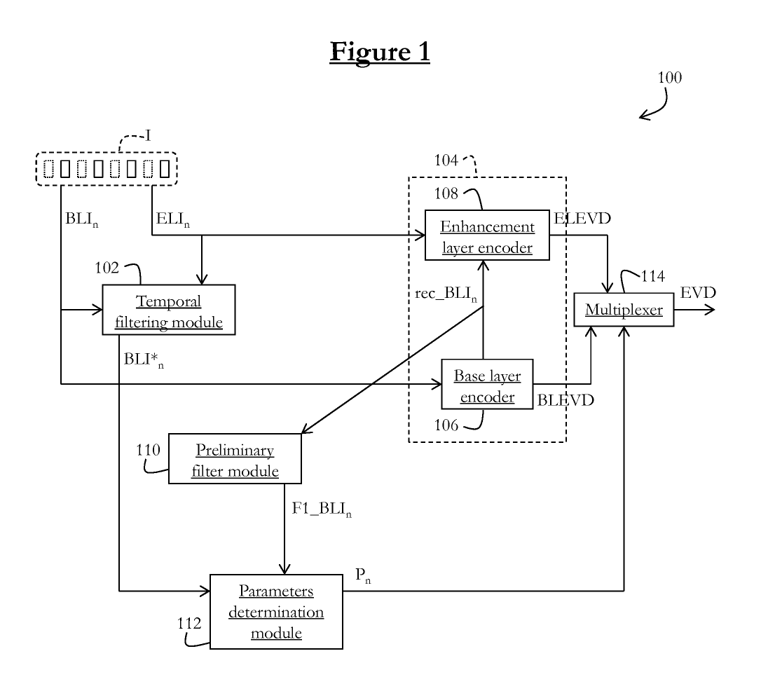

With reference to FIG. 1, a video encoding system 100 will now be described. The video encoding system 100 is configured to receive a video comprising a sequence of images I. The sequence of images I comprises base layer images BLIₙ (depicted with solid lines) and enhancement layer images ELIₙ (depicted with dotted lines). The enhancement layer images ELIₙ are interleaved between the base layer images ELIₙ. Preferably, the sequence of images I comprises one enhancement layer image ELIₙ every L base layer images BLIₙ, L being a predetermined integer for example equal to one or two. In the described example, the sequence of images I comprises 2N images and L is equal to 1, which means that the base layer images BLIₙ alternate with the enhancement layer images ELIₙ:

I=BLI₁,ELI₁, . . . ,BLIₙ,ELIₙ, . . . ,BLI_{N},ELI_{N}

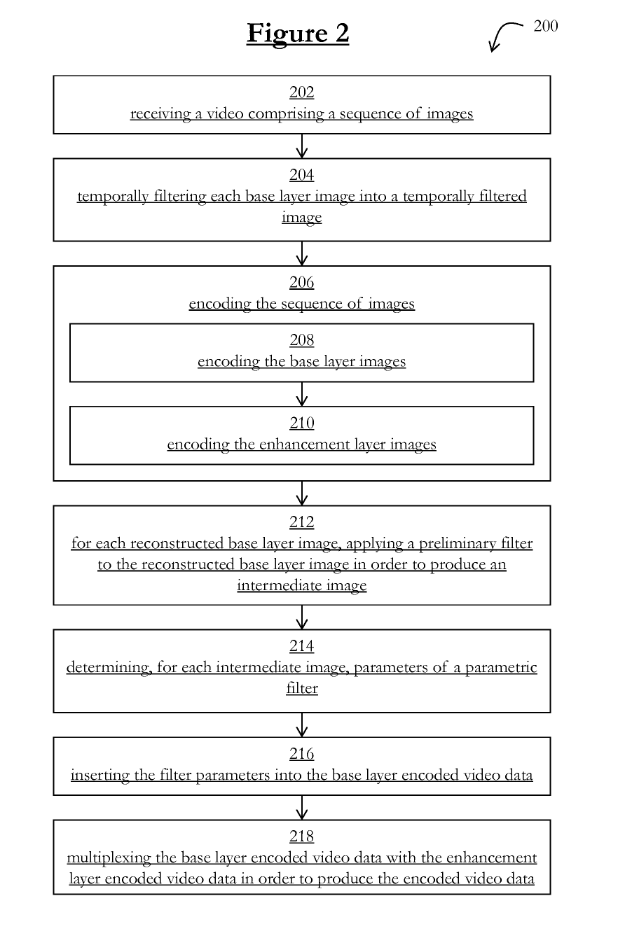

The elements of the video encoding system 100 will now be introduced and their functioning described in greater detail later, with reference to FIG. 2.

The video encoding system 100 comprises a temporal filtering module 102 configured to temporally filter each base layer image BLIₙ into a temporally filtered image BLIₙ*. The temporally filtered images BLIₙ* are intended to simulate what would have been produced by a camera shooting the video with a longer integration time. The temporal filtering leads to several modifications in the image, which may include for example motion blurring, as well as other optical effects.

The video encoding system 100 further comprises a video encoder 104 configured to encode the base layer images BLIₙ and the enhancement layer images ELIₙ in order to respectively provide base layer encoded video data BLEVD and enhancement layer encoded video data ELEVD.

The video encoder 104 comprises a base layer encoder 106 configured to encodes the base layer images BLIₙ in order to produce the base layer encoded video data BLEVD in the form of a base layer bitstream, and reconstructed base layer images rec_BLIₙ. According to a specific and non-limiting embodiment, the base layer encoder 106 is an H.264 or an HEVC compliant encoder.

The video encoder 104 further comprises an enhancement layer encoder 108 configured to encode the enhancement layer images ELIₙ in order to produce enhancement layer encoded video data ELEVD in the form of an enhancement layer bitstream. According to a specific and non-limiting embodiment, the enhancement layer encoder 108 is an H.264 or an HEVC compliant encoder.

The video encoding system 100 further comprises an optional preliminary filter module 110 configured, for each reconstructed base layer image rec_BLIₙ, to apply a preliminary filter F1 to the reconstructed base layer image rec_BLIₙ in order to produce an intermediate image F1_BLIₙ.

The video encoding system 100 further comprises a parameters determination module 112 configured to determine, for each reconstructed base layer image rec_BLIₙ, at least one filter parameter Pₙ of a parametric filter F2. The filter parameter(s) Pₙ is/are such that applying the parametric filter F2 with the filter parameter(s) Pₙ to a version of the reconstructed base layer image rec_BLIₙ produces a corrected base layer image cor_BLIₙ similar to the corresponding temporally filtered image BLIₙ*:

cor_BLIₙ=F2(int_BLIₙ)≈BLIₙ*

The version of the reconstructed base layer image rec_BLIₙ may be the reconstructed base layer image rec_BLIₙ itself, for instance when the preliminary filter module 110 is absent. Alternatively, the version of the reconstructed base layer image rec_BLIₙ may be the intermediate image F1_BLIₙ when the preliminary filter module 110 is present.

The corrected base layer image cor_BLIₙ is closer in content to the temporally filtered image BLIₙ* than the version of the reconstructed base layer image rec_BLIₙ.

This means that, according to a predetermined distance, the distance between the content of the corrected base layer image cor_BLIₙ and the content of the temporally filtered image BLIₙ* is smaller than the distance between the content of the version of the version of the reconstructed base layer image rec_BLIₙ and the content of the temporally filtered image BLIₙ*. The distance is for example a L2-norm.

The video encoder 100 optionally comprises a multiplexer 114 configured to multiplex the base layer encoded video data BLEVD with the enhancement layer encoded video data ELEVD in order to produce the encoded video data EVD in the form of a bitstream. The multiplexer 114 may also be configured to multiplex the filter parameters Pₙ with the base layer encoded video data BLEVD. Furthermore, the multiplexer 114 may be configured to transmit or to store the encoded video data EVD. The encoded video data EVD may be decoded by a decoder, such as the one described later, into a decoded video similar to the received video

In a variant, the multiplexer 114 is external to the video encoder 100.

With reference to FIG. 2, a video encoding method 200, for example carried out by the video encoding system 100, will now be described.

During a step 202, the video encoding system 100 receives the video comprising the sequence of images I.

During a step 204, the temporal filtering module 102 temporally filters each base layer image BLIₙ into a temporally filtered image BLIₙ.

Advantageously, one or several enhancement layer images ELIₙ are used for temporally filtering a base layer image BLIₙ. In this case, the temporal filtering corresponds to a down conversion since two images (or more) are used for computing a single image. Each of the enhancement layer images ELIₙ used for temporally filtering a base layer image BLIₙ may precede or follow this base layer image BLIₙ. For example, the directly preceding image ELIₙ₋₁ or directly following image ELIₙ may be used. In the described example, the directly preceding image ELIₙ₋₁ is used.

Advantageously, temporally filtering a base layer image BLIₙ comprises computing a mean of the base layer image BLIₙ with the enhancement layer image(s) ELIₙ used for the temporal filtering.

For example, in the case of the described example where the directly preceding image ELIₙ₋₁ is used, a temporally filtered image BLIₙ* may be obtained according to the following equation:

$$\vert {BLI}_{n}^{*} [ p ] \vert = \frac{\vert {BLI}_{n} [ p ] \vert + \vert {ELI}_{n - 1} [ p ] \vert}{2}$$

where p is a pixel of the temporally filtered image BLIₙ*, |BLIₙ* [p]| is the value of the pixel p in the temporally filtered image BLIₙ*, |BLIₙ[p]| is the value of the pixel p in the base layer image BLIₙ, and |ELIₙ₋₁[p]| is the value of the pixel p in the directly preceding enhancement layer image ELIₙ₋₁.

Alternatively, additional motion compensated frames from the base layer image BLIₙ and/or enhancement layer image(s) ELIₙ could be used to compute the mean. During a step 206, the video encoder 104 encodes the base layer images BLIₙ and the enhancement layer images ELIₙ in order to respectively produce base layer encoded video data BLEVD and enhancement layer encoded video data ELEVD.

More precisely, the step 206 comprises a step 208 during which the base layer encoder 106 encodes the base layer images BLIₙ in order to produce the base layer encoded video data BLEVD and reconstructed base layer images rec_BLIₙ.

Advantageously, the base layer images BLIₙ are encoded independently of the enhancement layer images ELIₙ.

Usually, in particular when the base layer encoder 106 is H.264 or HEVC compliant, for encoding a base layer image BLIₙ, this base layer image BLIₙ is first partitioned into coding units, e.g. into blocks or macroblocks, according to a partition called encoding partition.

Each coding unit is then encoded by determining a prediction of the coding unit. For determining the prediction, particularly in the case of inter prediction, motion vectors, called encoding motion vectors enc_MVₙ, are determined with respect to reconstructed coding units taken as references. The prediction is then determined from the encoding motion vectors enc_MVₙ and the reference reconstructed coding units.

A residual between the prediction and the coding unit is then determined and the residual is encoded. Classically, encoding the residual comprises applying a transformation T (e.g. a DCT) to the residual in order to produce coefficients, which are in turn quantized and entropy coded.

The coding unit is then reconstructed in order to produce a reconstructed coding unit. To this aim, the quantized coefficients are dequantized and the inverse transform T¹ is applied to the dequantized coefficients. The prediction is then added to the result of the inverse transform T⁻¹ in order to produce the reconstructed coding unit.

The reconstructed coding units may serve as reference when coding other coding units.

The reconstructed coding units obtained during the encoding of a base layer image BLIₙ forms a reconstructed base layer image rec_BLIₙ corresponding to this base layer image BLIₙ.

The step 206 further comprises a step 210 during which the enhancement layer encoder 108 encodes the enhancement layer images ELIₙ in order to produce the enhancement layer encoded video data ELEVD.

Advantageously, at least some of the enhancement layer images ELIₙ are encoded from the reconstructed base layer images rec_BLIₙ. In this case, the reconstructed base layer images rec_BLIₙ may be used in the prediction of the enhancement layer images ELIₙ.

During an optional step 212, for each reconstructed base layer image rec_BLIₙ, the preliminary filter module 110 applies the preliminary filter F1 to the corresponding reconstructed base layer image rec_BLIₙ in order to produce an intermediate image F1_BLIₙ:

F1_BLIₙ=F1(rec_BLIₙ)

In the described example, the preliminary filter F1 is a motion compensated temporal filter configured to filter the reconstructed base layer image rec_BLIₙ according to one or several other reconstructed base layer images, taken as reference images. Accordingly, in the described example, the step 212 is carried out as follows.

Motion vectors, called filtering motion vectors filt_MVₙ, are first determined, for example by carrying out motion estimation. Advantageously, at least one filtering motion vector filt_MVₙ is determined from at least one encoding motion vector enc_MVₙ. For example, an encoding motion vector enc_MVₙ is taken as the filtering motion vector filt_MVₙ. Alternatively, an encoding motion vector enc_MVₙ is used to derive a candidate (for example, it may be used directly as a candidate) in the motion estimation process for determining the filtering motion vector filt_MVₙ.

The preliminary filter module 110 then determines the intermediate image F1_BLIₙ from the filtering motion vectors filt_MVₙ and one or several other reconstructed base layer images rec_BLIₙ, taken as reference images.

For example, when the preliminary filter F1 is a linear motion compensated filter, the value of the pixel p in the intermediate image F1_BLIₙ is equal to a weighted sum of the value of the pixel p and the value(s) of the corresponding reference pixel(s) (i.e. the pixel(s) in the reference reconstructed base layer image(s)). For example, the two directly preceding images rec_BLIₙ₋₁ and rec_BLIₙ₋₂ may be taken as reference images. In this case, the value of each pixel p in the intermediate image F1_BLIₙ may be given by:

|F1_BLIₙ[p]|=w₀|rec_BLIₙ[p]|+w₁|rec_BLIₙ₋₁[p+k1.filt_MVₙ¹(p)]|+w₂|rec_BLIₙ₋₂[p+k2.filt_MVₙ²(p)]|

where |F1_BLIₙ[p]| is the value of the pixel p in the intermediate image F1_BLIₙ, |rec_BLIₙ[p]| is the value of the pixel p in the reconstructed base layer image rec_BLIₙ, |rec_BLIₙ₋₁[p+filt_MVₙ¹(p)]| is the value of a pixel located at the location p+k1.filt_MVₙ¹(p) in the reconstructed base layer image rec_BLIₙ₋₁, k1 is for example equal to 1.5 in order to increase the length of the first filtering motion vector so that the motion it represents corresponds to a time around n+1/2, |rec_BLIₙ₋₂[p+k2.filt_MVₙ²(p)]| is the value of a pixel located at the location p+k2.filt_MVₙ²(p) in the reconstructed base layer image rec_BLIₙ₋₂, k2 is for example equal to 1.25 in order to increase the length of the second filtering vector so that the motion it represents corresponds to a time around n+1/2, and w₀, w₁ and w₂ are the respective weights.

During a step 214, the parameters determination module 112 determines at least one filter parameter Pₙ of the parametric filter F2 for each reconstructed base layer image rec_BLIₙ.

In a particular embodiment where the preliminary filter F1 is applied, the step 214 comprises the followings steps.

The intermediate image F1_BLIₙ is first partitioned into blocks of pixels, called filtering blocks, according to a partition called filtering partition. For example, the filtering partition is equal to the encoding partition carried out by the base layer encoder 106.

For each filtering block, at least one parameter for the parametric filter F2 is determined, such that applying the parametric filter F2 to the filtering block with the parameter(s) produces a corresponding block of the corrected base layer image cor_BLIₙ.

In a first embodiment, the parametric filter F2 is a sample adaptive offset filter (SAO filter). In this case, one parameter of each filtering block is an offset. The offset is added to the value of each pixel p of the filtering block, in order to obtain the value of the corresponding pixel p in the corrected base layer image cor_BLIₙ:

|cor_BLIₙ[p]|=|F1_BLIₙ[p]|+Pₙ^{k}

where |cor_BLIₙ[p]| is the value of the pixel p in the corrected base layer image cor_BLIₙ, |F1_BLIₙ[p]| is the value of the pixel p in the intermediate image F1_BLIₙ, and Pₙ^{k} is the offset associated with the filtering block k to which the pixel p belongs.

Alternatively, the filter parameters Pₙ could be determined in a full-pel manner, which is equivalent to considering that each filtering block comprises only one pixel. In this case, the parameters determination module 112 determines one parameter for each pixel p, this parameter being an offset. The offset is added to the value of the pixel p, in order to obtain the value of the corresponding pixel p in the corrected base layer image cor_BLIₙ:

|cor_BLIₙ[p]|=|F1_BLIₙ[p]|+Pₙ(p)

where |cor_BLIₙ[p]| is the value of the pixel p in the corrected base layer image cor_BLIₙ, |F1_BLIₙ[p]| is the value of the pixel p in the intermediate image F1_BLIₙ, and Pₙ(p) is the offset associated with the pixel p.

Alternatively, the parameters determination module 112 could divide the pixels of each filtering block into a predetermined number of categories and then determine one parameter for each category for this filtering block. In this case, the value of each pixel p is intended to be added to the parameter for the category of the pixel p.

In the above alternatives, the offsets can be determined from the images F1_BLIₙ and BLIₙ* according to a method of the state of the art, such as the method disclosed in the document from Fu et al entitled “Sample Adaptive Offset for HEVC” published in MMPS in 2011 which is included herein by reference. It will be appreciated, however, that the invention is not restricted to this specific method for determining the offsets.

In another embodiment, the parametric filter F2 is an adaptive loop filter. In this case, the parameters determination module 112 determines, for each filtering block, several filter parameters. For each pixel p of the filtering block, the filter parameters are weights of a linear combination of the values of the pixel p and neighboring pixels of the pixel p. The filter parameters can be determined from the images F1_BLIₙ and BLIₙ* according to a method of the state of the art such as the method disclosed in the document from Zheng et al entitled “directional adaptive loop filter for video coding “published in ICIP in 2011 which is included herein by reference. It will be appreciated, however, that the invention is not restricted to this specific method for determining the offsets.

When the version of the reconstructed base layer image rec_BLIₙ is the reconstructed base layer image rec_BLIₙ itself, the same previous steps may be carried out during step 214, in which case the intermediate image F1_BLIₙ is replaced by the reconstructed base layer image rec_BLIₙ.

During a step 216, the filter parameters Pₙ are inserted into the base layer encoded video data BLEVD. According to a specific and non-limiting embodiment, the base layer encoder 106 encodes the filter parameters Pₙ into the base layer encoded video data BLEVD. In a variant, the multiplexer 114 multiplexes the filter parameters Pₙ with the base layer encoded video data BLEVD.

During an optional step 218, the multiplexer 114 multiplexes the base layer encoded video data BLEVD with the enhancement layer encoded video data ELEVD in order to produce the encoded video data EVD.

The video encoding system 100 then provides the encoded video data EVD, which comprises the base layer encoded video data BLEVD, the enhancement layer encoded video data ELEVD and, in the base layer encoded video data BLEVD, the parameters Pₙ.

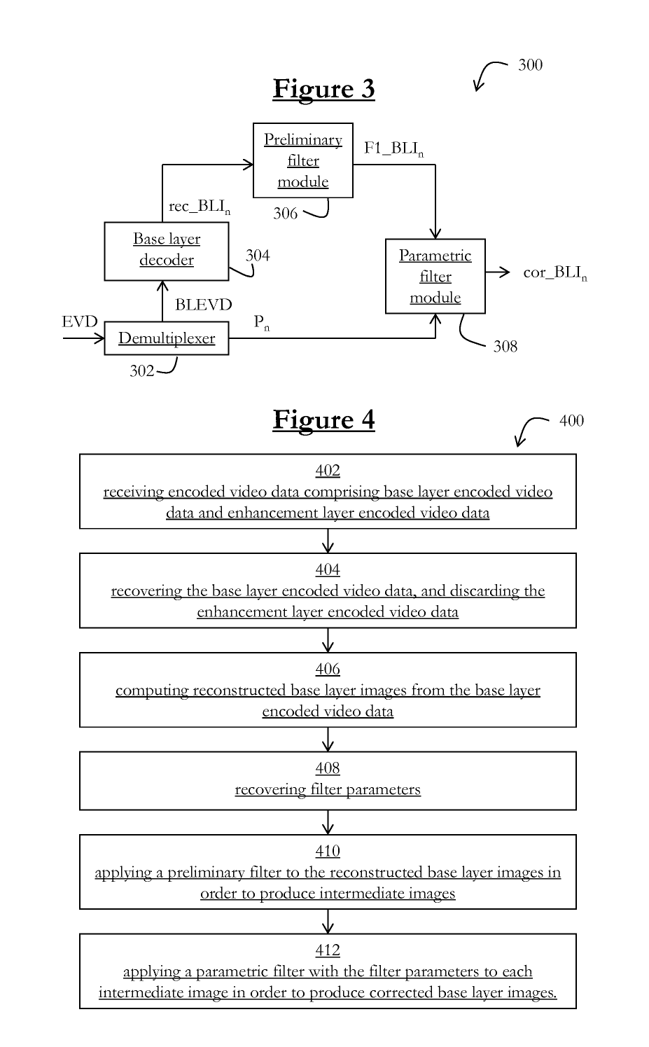

With reference to FIG. 3, a video decoder 300 will now be described.

The video decoder 300 is configured to receive encoded video data EVD, for example from the video encoder 100. The video decoder 300 is a low frame rate video decoder configured to decode the base layer images BLIₙ and to discard the enhancement layer images ELIₙ. The encoded video data EVD comprises base layer encoded video data BLEVD, enhancement layer encoded video data ELEVD and filter parameters Pₙ.

The video decoder 300 optionally comprises a demultiplexer 302 configured to recover the base layer encoded video data BLEVD, in which the filter parameters Pₙ are inserted (for example, by encoding or multiplexing), and to discard the enhancement layer encoded video data ELEVD. In a variant, the demultiplexer 302 is external to the video decoder 300. In this case, the video decoder 300 is configured to receive the base layer encoded video data BLEVD.

The video decoder 300 further comprises a base layer decoder 304 configured to compute reconstructed base layer images rec_BLIₙ the base layer encoded video data BLEVD. According to a specific embodiment and non-limiting embodiment, the base layer decoder 304 is an H.264 or an HEVC compliant decoder. If necessary, the base layer decoder 304 is further configured to decode the filter parameters Pₙ from the base layer encoded video data BLEVD. In any case, each reconstructed base layer image rec_BLIₙ is associated with at least one of the parameters Pₙ that have been received.

The video decoder 300 further comprises an optional preliminary filter module 306 configured to apply the preliminary filter F1 (similar to the one of the video encoding system 100) to the reconstructed base layer images rec_BLIₙ in order to produce the intermediate images F1_BLIₙ.

The video decoder 300 further comprises a parametric filter module 308 configured, for each reconstructed base layer image rec_BLIₙ, to apply the parametric filter F2 (similar to the one of the video encoding system 100) with the filter parameter(s) Pₙ associated to the reconstructed base layer image rec_BLIₙ to a version of the reconstructed base layer image rec_BLIₙ in order to produce a corrected base layer image cor_BLIₙ. When the preliminary filter module 306 is present, the version of the reconstructed base layer image rec_BLIₙ may be the intermediate image F1_BLIₙ. In the case the preliminary filter module 306 is absent, the version of the reconstructed base layer image rec_BLIₙ may be the reconstructed base layer image rec_BLIₙ itself.

With reference to FIG. 4, a video decoding method 400, for example carried out by the video decoder 300, will now be described.

During a step 402, the video decoder 300 receives the encoded video data EVD.

During an optional step 404, the demultiplexer 302 recovers the base layer encoded video data BLEVD, and discards the enhancement layer encoded video data ELEVD.

In a variant, during the step 402, the video decoder 300 receives only the base layer encoded video data BLEVD. In this case, there is no step 404.

During a step 406, the base layer decoder 304 computes reconstructed base layer images rec_BLIₙ from the base layer encoded video data BLEVD.

Usually, in particular when the base layer decoder 304 is H.264 or HEVC compliant, for computing a reconstructed base layer image rec_BLIₙ, the reconstructed base layer image rec_BLIₙ is first partitioned into coding units, e.g. into blocks or macroblocks, according to the encoding partition.

Each coding unit is then reconstructed by determining a prediction of the coding unit. For determining the prediction, particularly in the case of inter prediction, the encoding motion vector are decoded from the base layer encoded video data BLEVD and applied to reference reconstructed coding units, that is to say coding units that have already been reconstructed.

A residual for the coding unit is then decoded from the base layer encoded video data BLEVD and added to the prediction to reconstruct the coding unit. The residual is classically decoded by entropy decoding parts of the base layer encoded video data BLEVD, and by applying an inverse quantization and an inverse transform (e.g. an inverse DCT).

The set of reconstructed coding units forms the reconstructed base layer image rec_BLIₙ.

During a step 408, for each reconstructed base layer image rec_BLIₙ, the associated filter parameter(s) Pₙ is/are recovered. In a specific and non-limiting embodiment, the base layer decoder 304 decodes the filter parameters Pₙ from the base layer encoded video data BLEVD. In a variant, the demultiplexer 302 recovers the base layer encoded video data BLEVD and the filter parameters Pₙ. This variant applies when, during the step 216, the filter parameters Pₙ and the base layer encoded video data BLEVD are multiplexed.

During an optional step 410, for each reconstructed base layer images rec_BLIₙ, the preliminary filter module 306 applies the preliminary filter F1 (similar to the one of the video encoding system 100) to the reconstructed base layer image rec_BLₙ in order to produce the corresponding intermediate image F1_BLIₙ.

During a step 412, for each reconstructed base layer images rec_BLIₙ, a parametric filter module 308 applies a parametric filter F2 with the filter parameter(s) Pₙ associated to the reconstructed base layer image rec_BLIₙ the version of the reconstructed base layer image rec_BLIₙ order to produce the corresponding corrected base layer image cor_BLIₙ.

When the step 410 (preliminary filtering) is carried out, the version of the reconstructed base layer image rec_BLIₙ may be the intermediate image F1_BLIₙ. In the contrary, the version of the reconstructed base layer image rec_BLIₙ may be the reconstructed base layer image rec_BLIₙ itself.

In this manner, the video decoder 300 provides corrected base layer image cor_BLIₘ which are similar to the temporally filtered images BLIₙ* determined in the video encoding 100.

The corrected base layer images cor_BLIₙ may then be successively displayed on a display screen (not depicted), without any noticeable stroboscopic effect.

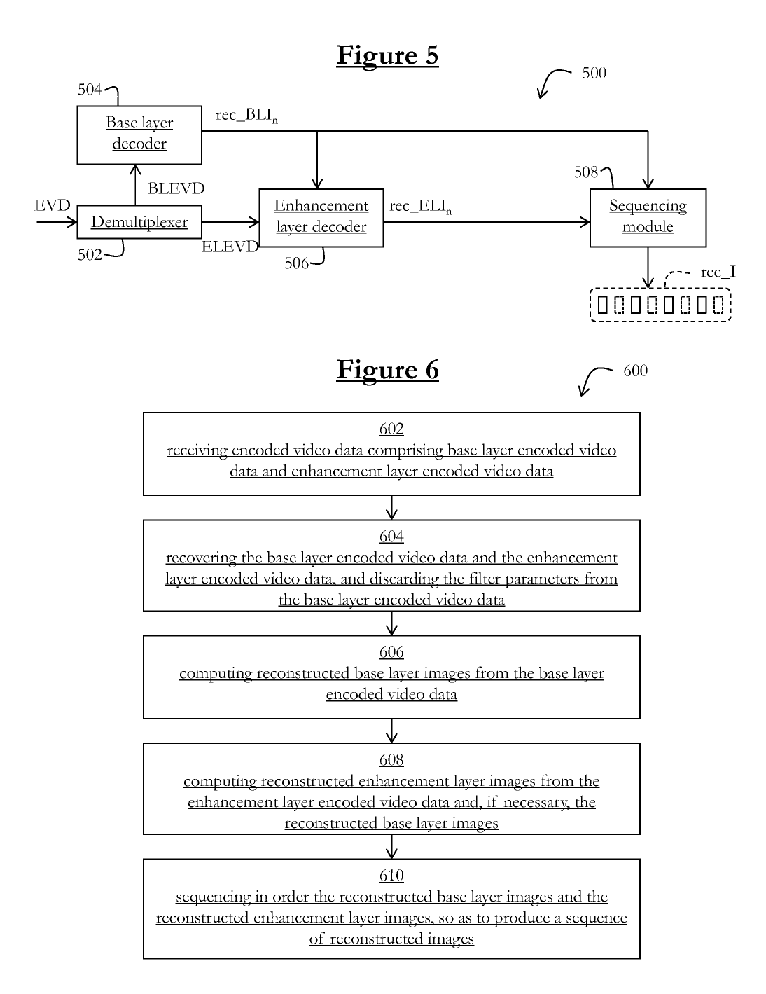

With reference to FIG. 5, a video decoder 500 will now be described.

The video decoder 500 is configured to receive encoded video data EVD, for example from the video encoder 100. The video decoder 500 is a high frame rate video decoder configured to decode both the base layer images and the enhancement layer images.

The video decoder 500 first comprises a demultiplexer 502 configured to recover the base layer encoded video data BLEVD and the enhancement layer encoded video data ELEVD, and to discard the filter parameters Pₙ. In a variant, the demultiplexer 502 is external to the video decoder 500.

The video decoder 500 further comprises a base layer decoder 504 intended to compute reconstructed base layer images rec_BLIₙ from the base layer encoded video data BLEVD. In this case, the filter parameters Pₙ are discarded by the video decoder 500.

The video decoder 500 further comprises an enhancement layer decoder 506 configured to compute reconstructed enhancement layer images rec_ELIₙ from the enhancement layer encoded video data ELEVD and, if necessary, the reconstructed base layer images rec_BLIₙ.

The video decoder 500 further comprises a sequencing module 508 configured to sequence in order the reconstructed base layer images rec_BLIₙ and the reconstructed enhancement layer images rec_ELIₙ, so as to produce a sequence of reconstructed images rec_I.

The reconstructed images rec_I may for example be displayed on a display screen (not depicted).

With reference to FIG. 6, a video decoding method 600, for example carried out by the video decoder 500, will now be described.

During a step 602, the video decoder 500 receives the encoded video data EVD.

During an optional step 604, the demultiplexer 502 recovers the base layer encoded video data BLEVD and the enhancement layer encoded video data ELEVD, and discards the filter parameters Pₙ from the base layer encoded video data BLEVD.

During a step 606, the base layer decoder 504 recovers if necessary the filter parameters Pₙ from the base layer encoded video data BLEVD and computes the reconstructed base layer images rec_BLI from the base layer encoded video data BLEVD.

During a step 608, the enhancement layer decoder 506 computes the reconstructed enhancement layer images rec_ELIₙ from the enhancement layer encoded video data ELEVD and, if necessary, the reconstructed base layer images rec_BLIₙ.

During a step 610, the sequencing module 508 sequences in order the reconstructed base layer images rec_BLIₙ and the reconstructed enhancement layer images rec_ELIₙ, so as to produce a sequence of reconstructed images rec_I.

In this manner, the video decoder 500 provides reconstructed base layer image rec_BLIₙ and reconstructed enhancement layer images rec_ELIₙ, without any temporal filtering.

The corrected base layer images cor_BLIₙ may then be successively displayed on a display screen (not depicted), without any noticeable loss in quality.

As it is apparent from the previous description, the invention allows to produce a temporally scalable video which can be decoded by a low frame rate decoder to produce base layer images avoiding flickering effects, and which can be decoded by a high frame rate decoder to produce base and enhancement layer images without any blurring of the base layer images degrading the video quality.

The present invention is not limited to the embodiment previously described, but instead defined by the appended claims. It will in fact be apparent to the one skilled in the art that modifications can be applied to the embodiment previously described.

For example, the preliminary filter module 110 could be omitted, so that the parametric filter module 112 would receive directly the reconstructed base layer images rec_BLI.

It should be noted that FIGS. 2, 4 and 6 illustrate only one possible way to carry out the methods steps. In other embodiments, the steps of each method could be carried out concurrently and/or in any possible order.

Besides, the terms used in the appended claims shall not be understood as limited to the elements of the embodiments previously described, but on the contrary shall be understood as including all equivalent elements that the one skilled in the art is able to derive using their general knowledge.

1. A video encoding method comprising:
receiving a video comprising a sequence of images, the sequence of images comprising base layer images and enhancement layer images,
temporally filtering each base layer image into a temporally filtered image from at least one enhancement layer image,
encoding the base layer images in order to produce base layer encoded video data and reconstructed base layer images,
encoding the enhancement layer images in order to produce enhancement layer encoded video data,
determining at least one parameter of a parametric filter for each reconstructed base layer image, such that applying the parametric filter with the parameter(s) to a version of the reconstructed base layer image produces a corrected base layer image which is closer to the temporally filtered image than the version of the reconstructed base layer image,
providing the base layer encoded video, the enhancement layer encoded video and the parameters.

2. The video encoding method according to claim 1, wherein the version of the reconstructed base layer image is the reconstructed base layer image itself.

3. The video encoding method according to claim 1, comprising applying a preliminary filter to each reconstructed base layer image, and wherein the version of each reconstructed base layer image is the intermediate image for this reconstructed base layer image.

4. The video encoding method according to claim 3, wherein the preliminary filter is independent of the parameters.

5. The video encoding method according to claim 3, wherein encoding the base layer images comprises, for at least one base layer image, determining motion vectors, called encoding motion vectors, and wherein applying the preliminary filter to the reconstructed base layer image comprises determining motion vectors, called filtering motion vectors, used by the preliminary filter, at least one filtering motion vector being determined from at least one encoding motion vector.

6. The video encoding method according to claim 5, wherein, for determining at least one filtering motion vector, an encoding motion vector is used to derive a candidate in a motion estimation process for determining the filtering motion vector.

7. The video encoding method according to claim 5, wherein the preliminary filter comprises a motion compensated temporal filter.

8. The video encoding method according to claim 1, wherein the corrected base layer image being closer to the temporally filtered image than the version of the reconstructed base layer image means that, according to a predetermined distance, the distance between the content of the corrected base layer image and the content of the temporally filtered image is smaller than the distance between the content of the version of the reconstructed base layer image and the content of the temporally filtered image.

9. The video encoding method according to claim 1, wherein, for at least one base layer image, the temporal filtering is carried out from at least one enhancement layer image by computing a mean of the base layer image and the enhancement layer image(s)).

10. The video encoding method according to claim 1, wherein encoding the base layer images comprises, for at least one base layer image:
partitioning the base layer image into coding units according to a partition, called encoding partition, and
and wherein determining the parameters comprises:
partitioning the version of the reconstructed base layer image into filtering blocks according to the encoding partition,
determining, for each filtering block, at least one parameter for the parametric filter, such that applying the parametric filter to the filtering block with the parameter(s) produces a corresponding block of the corrected base layer image.

11. The video encoding method according to claim 1, wherein the parametric filter comprises an adaptive loop filter or a sample adaptive offset filter.

12. A non-transitory computer readable medium with instructions stored therein which, upon execution, instruct at least one processor to:
receive a video comprising a sequence of images, the sequence of images comprising base layer images and enhancement layer images,
temporally filter each base layer image into a temporally filtered image from at least one enhancement layer image,
encode the base layer images in order to produce base layer encoded video data and reconstructed base layer images,
encode the enhancement layer images in order to produce enhancement layer encoded video data,
determine at least one parameter of a parametric filter for each reconstructed base layer image, such that applying the parametric filter with the parameter(s) to a version of the reconstructed base layer image produces a corrected base layer image which is closer to the temporally filtered image than the version of the reconstructed base layer image,
provide the base layer encoded video, the enhancement layer encoded video and the parameters.

13. Video encoding system comprising:
a receiver configured to receive a video comprising a sequence of images comprising base layer images and enhancement layer images
a temporal filtering module configured to temporally filter each base layer image into a temporally filtered image from at least one enhancement layer image,
a base layer encoder configured to encode the base layer images in order to produce base layer encoded video data and reconstructed base layer images,
an enhancement layer encoder configured to encode the enhancement layer images in order to produce enhancement layer encoded video data,
a parameters determination module configured to determine at least one parameter of a parametric filter for each reconstructed base layer image, such that applying the parametric filter with the parameter(s) to a version of the reconstructed base layer image produces a corrected base layer image which is closer to the temporally filtered image than the version of the reconstructed base layer image,
the video encoding system being configured to provide the base layer encoded video, the enhancement layer encoded video and the parameters.

14. The video encoding system according to claim 13, wherein the version of the reconstructed base layer image is the reconstructed base layer image itself.

15. The video encoding system according to claim 13, comprising a module configured to apply a preliminary filter to each reconstructed base layer image, and wherein the version of each reconstructed base layer image is the intermediate image for this reconstructed base layer image.

16. The video encoding method system to claim 15, wherein the preliminary filter is independent of the parameters.

17. The video encoding system according to claim 15, wherein the base layer encoder is configured, for at least one base layer image, to determine motion vectors, called encoding motion vectors, and wherein the module configured to apply a preliminary filter to each reconstructed base layer image is configured to determine motion vectors, called filtering motion vectors, used by the preliminary filter, at least one filtering motion vector being determined from at least one encoding motion vector.

18. The video encoding system according to claim 17, wherein, to determine at least one filtering motion vector, an encoding motion vector is used to derive a candidate in a motion estimation process for determining the filtering motion vector.

19. The video encoding system according to claim 17, wherein the preliminary filter comprises a motion compensated temporal filter.

20. The video encoding system according to claim 13, wherein the corrected base layer image being closer to the temporally filtered image than the version of the reconstructed base layer image means that, according to a predetermined distance, the distance between the content of the corrected base layer image and the content of the temporally filtered image is smaller than the distance between the content of the version of the reconstructed base layer image and the content of the temporally filtered image.

21. The video encoding system according to claim 13, wherein the temporal filtering module is configured to temporally filter at least one base layer image from at least one enhancement layer image by computing a mean of the base layer image and the enhancement layer image(s).

22. The video encoding system according to claim 13, wherein the base layer encoder is configured to:
partition at least one base layer image into coding units according to a partition, called encoding partition, and
and wherein the parameters determination module is configured to:
partition the version of the reconstructed base layer image into filtering blocks according to the encoding partition,
determine, for each filtering block, at least one parameter for the parametric filter, such that applying the parametric filter to the filtering block with the parameter(s) produces a corresponding block of the corrected base layer image.

23. The video encoding system according to claim 13, wherein the parametric filter comprises an adaptive loop filter or a sample adaptive offset filter.
